(19) United States
(12) Patent Application Publication
(10) Pub. No.: US 2013/0020430 A1
(43) Pub. Date: Jan. 24, 2013

(54) Method of Extending and Improving Aircraft Life and Efficiency

(71) Applicants: Rodney T. Cox, North Plains, OR (US); Joseph J. Cox, Portland, OR (US); Isaiah W. Cox, Baltimore, MD (US)

(72) Inventors: Rodney T. Cox, North Plains, OR (US); Joseph J. Cox, Portland, OR (US); Isaiah W. Cox, Baltimore, MD (US)

(73) Assignee: BOREALIS TECHNICAL LIMITED, London (GB)

(21) Appl. No.: 13/555,224

(22) Filed: Jul. 23, 2012

Related U.S. Application Data
(60) Provisional application No. 61/510,919, filed on Jul. 22, 2011.

(51) Int. Cl. B64C 25/50

(52) U.S. Cl. 244/50

(57) ABSTRACT

A method for extending the useful and economic life of an aircraft and improving aircraft efficiency is provided. This method produces significant fuel savings on the ground and in flight as well as cost-effective and efficient operation of and reduced maintenance requirements for older aircraft. The increased economic viability of the continued use of older aircraft is achieved by equipping an aircraft with at least one onboard drive wheel assembly controllably powered to drive the aircraft during ground travel independently of aircraft engines or external tow vehicles. The substantial elimination of damage to an aircraft's airframe, brakes, landing gear, and engine components resulting from tow vehicle attachment, brake application during ground travel with operating aircraft engines, or by FOD produces cleaner, more efficient engine operation during flight. Significant and substantial potential cost savings realized by the present method makes the continued use of older aircraft a viable option.

### PRIORITY CLAIM

This application claims priority from U.S. Provisional Application No. 61/510,919, filed Jul. 22, 2011, the disclosure of which is incorporated herein.

### TECHNICAL FIELD

The present invention relates generally to extending the useful life of an aircraft and specifically to a method that extends and improves aircraft efficiency and economic life.

### BACKGROUND OF THE INVENTION

The useful life of an aircraft can be affected by many factors and is often difficult to predict. The decision to “retire” an aircraft can also be based on many considerations. Changes in technology, business cycles, fuel prices, noise and emissions requirements, and the economy, for example, can impact an aircraft's effective service life. Although the earliest generation of jet aircraft had relatively short useful lives in the range of 10 to 20 years or even less, today's aircraft are in service significantly longer. Some studies show 30 to 35 years to be the median length of service before an aircraft is retired. Some groups of aircraft, the DC-8 freighters in particular, tend to have unusually long effective lives, and many are still in operation after 40 years.

The economic and financial environment of the past several years has led airlines to postpone the acquisition of new aircraft, although this appears to be changing in view of very large orders placed recently for new aircraft to be delivered in the 2115 to 2125 time horizon. This is likely to limit the availability of new aircraft to those airlines that did not place orders. Currently, the average age of many, if not most, airlines' fleets of aircraft has increased and will continue to do so for the next several years. Low cost passenger and cargo carriers, in the United States and elsewhere, have tended to purchase used aircraft, with the result that older aircraft are kept operating longer than would have been the case in the not too distant past. It has been estimated by the International Air Transport Association (IATA) that about 35% of United States airlines' aircraft are more than 25 years old. Other reports have documented a steady increase in the average age of aircraft operated by U.S. airlines. Airlines are currently under pressure to maximize operation of their existing fleets while reducing the costs of flying. Additional pressures are being applied on airlines to increase fuel efficiency, reduce greenhouse gas emissions, and generally minimize the impact of aircraft on air quality and climate change. Since aging aircraft are less fuel efficient and may lack the technology to reduce emissions, these pressures are presenting significant challenges to airline operators. To meet these challenges in the current economic environment where it could prove difficult to fund the new replacement aircraft ordered or optioned, airlines continue to look for possible ways to extend the useful economic lives of their aging aircraft.

A significant factor in effectively operating older aircraft is the availability and cost of fuel. Older aircraft are typically substantially less fuel efficient than newer aircraft. The cost of maintenance for older aircraft is also a consideration. FAA maintenance and inspection requirements tend to be more extensive for older aircraft. Fuel and maintenance costs notwithstanding, there are economic advantages associated with extending the useful life of an older aircraft rather than replacing it with a new one. A new commercial jet aircraft, such as a 737-800, in the present market can cost in the neighborhood of US$50 to US$70 million. While the fuel savings and maintenance advantages are desirable, an investment of this magnitude can take a significant amount of time before a return on the investment is realized. In contrast, an older aircraft can be brought up to date for a fraction of this amount, typically about US$4 to US$5 million, although the cost could be much greater if the aircraft is re-engined. While many improvements can be made to modernize older aircraft, those that make the aircraft more cost-efficient to operate and extend its useful life are the most desirable and generally cost the most money. When improvements require an aircraft to be out of service for an extended period of time, the present net value of the improvements is dramatically reduced. Therefore, changes made to an existing aircraft to increase efficiency or extend useful life must increase the aircraft's present discounted value, which includes adding to the aircraft's economic life.

Suggestions have been made in the art that can result in extended aircraft life. For example, Science Daily (http://www.sciencedaily.com/releases/2009/03/090318090146.htm) reported increasing the useful life and reliability of aircraft by repairing fatigued and corroded aircraft structures with patches made from a composite material applied using nanotechnology. Ten-Huei Guo of the NASA Glenn Research Center describes a system for extending the life of aircraft engines and engine components in A Roadmap for Aircraft Engine Life Extending Control that is designed to reduce engine operating costs by extending the on-wing engine life while improving operational safety. In Patent Application Publication No. US2007/0157447, Prevey discloses a method for improving fatigue performance and resistance to stress related failure associated with foreign object debris (FOD) and high cycle fatigue in aircraft components. Apparatus for the reduction of FOD has been proposed. U.S. Pat. No. 7,051,509 to Grimlund, for example, describes a movable door positioned to block an aircraft engine inlet to prevent FOD ingestion while the aircraft is traveling on the ground with the engines operating. Patent Application Publication No. US2009/0177506 to Jiang describes a method whereby airlines can use a computer program to evaluate an airline's fleet composition so that the airline can determine the economical viability of aircraft in the fleet. While each of the foregoing suggestions may be of some use in extending aircraft life, none addresses the major concern of achieving fuel savings, which is essential to extending an aircraft's economic life. Moreover, none of the foregoing publications even remotely mentions the possibility of extending an aircraft's economic life by retrofitting the aircraft with a fuel and cost-saving electric drive wheel assembly that moves the aircraft on the ground while minimizing aircraft exposure to FOD and/or other factors that shorten aircraft effective operating life.

The prior art, therefore, while acknowledging the desirability of extending the useful life of aircraft, fails to suggest apparatus or method capable of extending not only an aircraft's useful life, but, additionally, an aircraft's economic life so that it becomes cost-effective to operate an older aircraft. A need exists for such a method.

### SUMMARY OF THE INVENTION

It is a primary object of the present invention, therefore, to provide a method for extending an aircraft's useful life and, simultaneously, the aircraft's economic life.

It is another object of the present invention to provide a method for extending aircraft life and efficiency.

It is an additional object of the present invention to provide a method for maintaining the economic viability of an aircraft.

It is a further object of the present invention to provide a method for enabling airlines economically to use the older aircraft in their fleets and to delay the purchase of new aircraft.

It is yet another object of the present invention to provide a cost-effective method for extending the useful and economic life of an aircraft.

It is yet an additional object of the present invention to provide a method for increasing and extending the operational efficiency of an aircraft.

It is yet a further object to provide a method for extending aircraft useful life by eliminating damage from FOD while an aircraft is traveling on the ground and improving engine performance and efficiency.

It is a still further object of the present invention to provide a method for increasing the economic viability of an aircraft.

It is a still further object of the present invention to provide a method for generating significant aircraft fuel savings in flight by maintaining cleaner, better running turbines as a result of reducing FOD on the ground

It is a still further object of the present invention to provide a method for substantially reducing maintenance to an aircraft's brakes by reducing brake use and the effect of brake use on during taxi on the structural integrity of the airframe.

The foregoing objects are achieved by providing a method for simultaneously extending both an aircraft's useful life and an aircraft's economic life by substantially reducing the need for maintenance of the aircraft's brakes and airframe, by substantially eliminating FOD damage, and by producing significant fuel savings on the ground and in flight. This is achieved by retrofitting an aircraft with at least one powered electric drive wheel assembly controllable to move the aircraft on the ground between landing and takeoff without the operation of the aircraft's engines or the need for a tow vehicle.

Other objects and advantages will be apparent from the following description, claims, and drawing.

### BRIEF DESCRIPTION OF THE DRAWING

FIG. 1 is a table comparing the fuel flow at idle for five different types of aircraft engines.

### DESCRIPTION OF THE INVENTION

Manufacturers of commercial aircraft currently in operation typically estimated a useful service life of about 20 years and/or 60,000 flights or cycles when the aircraft entered into service. A large number of aircraft flying today have exceeded these estimates. The high cost of replacement compared to refurbishing older aircraft has meant that fewer aircraft retire after 20 years or 60,000 cycles. Aircraft are not retired because they are technologically obsolete, but because they are no longer economically viable and cost too much to operate. That equation, however, has changed as the economy has changed. While some major airlines are selling their aging aircraft to developing countries, others are keeping their older aircraft rather than replacing them. As global economic challenges continue, it is important for airlines to implement strategies and adopt cost-effective solutions that extend the lives of their older aircraft and make them more efficient to operate, if at all possible. In the current economic climate, replacing an older aircraft with a new one may not necessarily be the competitive advantage it was in the past.

Obtaining and maintaining a ready supply of sufficient fuel is a major cost of operating a fleet of aircraft. Older aircraft are not as fuel efficient as newer aircraft. Consequently, airlines are constantly in search of anything that can be done to reduce aircraft fuel costs. Operating the aircraft's engines to move an aircraft on the ground from the gate areas to the taxiways to the runway, and at any other time when the aircraft is moved on the ground, for example to another gate or a maintenance location, adds significantly to fuel costs.

Maintaining efficient engine performance is another cost that tends to be higher with an older aircraft than a newer aircraft. One of the main causes of reduced engine efficiency in flight is engine damage resulting from foreign object debris (FOD) that occurs while the aircraft is traveling on the ground in gate areas and on taxiways with its engines running. Foreign object debris can include almost anything that is close enough to an operating aircraft engine to be sucked into the engine nacelle and the area close to the rotating turbines, an event referred to as engine ingestion. If the FOD includes hard materials, such as, for example, aircraft bolts, maintenance tools, bits of runway paving, or soft drink cans, this material hits against the turbine blades and causes damage ranging from small scratches to large dents. What appears to be a small amount of damage can produce inefficiencies in blade operation, which causes blade blending. Over time, this type of damage, corrected or uncorrected, accumulates and will interfere with engine efficiency. An inefficiently operating engine uses more fuel during flight than an efficiently operating engine. An engine that has not been damaged by FOD can operate with greater efficiency and, thus, less fuel during flight. With the method of the present invention, turbine blades are less likely to accumulate FOD damage, in large part because the engines are in operation for only the takeoff roll, which is a relatively short time while the aircraft is on the ground and significantly limits opportunities for FOD to be picked by engine ingestion. According to accepted studies, 85% of FOD is ingested on taxiways and in ramp areas. Runways are constantly checked, and the damage from runway FOD is generally minor, except in catastrophic circumstances during takeoff. Consequently, when engine turbines are not run in gate areas and taxiways, engine turbines are cleaner and run better while the aircraft is in flight, which leads to significant, measurable fuel savings during flight.

Older aircraft engines are less efficient than newer engines during taxi, in large part because of the presence of FOD damage to engine components accumulated over time during engine operation to move aircraft on the ground. Even with blade blending, accumulated FOD damage makes an older aircraft more expensive to operate than a newer aircraft, from the perspective of both increased engine maintenance costs and increased fuel costs. Aircraft brakes also require increased maintenance as an aircraft ages and as the brakes fight against the engine to keep the aircraft under control as it moves over the taxiways and ramp areas. Aircraft engines are designed to operate optimally at altitude and at air travel speeds rather than at ground speeds that vary from a standstill to about 30 miles per hour. The use of the brakes, first to slow the aircraft on landing, and then to try to maintain a constant, smooth taxi speed, as is currently done, can shorten the effective life of the brakes and lead to frequent repairs or replacement of the brakes. The application of brakes during aircraft ground travel when engines are running is typically not a smooth operation and can cause the aircraft to jerk as brakes are applied to moving wheels. Shocks to the airframe that accompany the described brake use are an additional adverse effect.

Increased maintenance may also be required when aircraft are pushed back by tow vehicles prior to takeoff or towed on the ground for any reason. The irregular and inconsistent attachment of a tow bar or tow vehicle can, over time, also cause as much damage to an aircraft's airframe as the application of brakes during ground travel. This can subject an aircraft to stresses which it was not designed to sustain. The attachment operation, moreover, can jolt the landing gear as well as the airframe, leading to long term maintenance challenges and affecting the useful life of both the landing gear and the airframe. As a result, aging aircraft tend to have a lower economic value due to damage to the braking system, the landing gear system, and the airframe.

The method of the present invention increases the economic value of aging aircraft by effectively reducing fuel costs and improving aircraft operating efficiency. Aircraft engines are not required for ground movement of the aircraft. Damage caused by braking during ground travel is substantially less likely to occur because the brakes are required only minimally, if at all, to control aircraft ground travel once the aircraft engines have been shut off. As a result, ground travel is smooth, and damage to the landing gear and airframe should be substantially minimized or avoided entirely. Since tow vehicles are not used or needed with the present method, damage due to tow vehicle attachment is completely eliminated. FOD damage is also substantially eliminated, and fuel efficiency, both on the ground and in flight, is substantially increased. As discussed above, a major advantage of eliminating FOD damage is the cleaner and long term more efficiently operating turbines. When engine turbines operate more efficiently during flight, less fuel is required, and substantial additional fuel savings in flight are realized. As a result, the present method can significantly increase the economic viability and useful life of older aircraft.

Currently, almost all of the ground movement between landing and take off of the vast majority of aircraft is produced by the operation of one or more of the aircraft's engines to power the aircraft from the point of touchdown on a runway to a parking location at an air terminal and then from the parking location to the point of takeoff. Tow vehicles, used by many, if not most, aircraft, push the aircraft back from a gate or parking location at departure. When tow vehicles are used, the aircraft engines are turned off. Otherwise, the engines operate at full or reduced thrust levels to move the aircraft when ground movement is required. When the engines are running and aircraft movement must be restrained, the aircraft brakes are typically applied, which increases the incidence of brake damage, as it is almost impossible to brake in a consistently smooth manner. It should be noted that the method of the present invention will provide a very large reduction in braking activity with a corresponding increase in brake life, along with a substantial decrease in shocks to the airframe from braking. Other causes of airframe shocks, including engine operation during ground travel and the attachment of tow vehicles, are substantially eliminated.

Whenever an aircraft's engines are operating, they are consuming fuel. Even when the aircraft is stopped and the engines are idling, not only is fuel consumed, but there is also a high likelihood of FOD damage from FOD pulled into the engine by engine ingestion. The method of the present invention substantially eliminates the need for engine operation when aircraft are on the ground and, thus, the need for this extra fuel. Engines that are not operating do not experience the occurrence of engine FOD damage.

In the present method of extending aircraft engine life and improving aircraft economic life, aircraft ground movements are powered and controlled by the operation of an onboard electric drive assembly. Consequently, once the aircraft engines are shut down upon landing, they remain shut down and inoperative until the aircraft is on a runway prior to takeoff. Aircraft fuel use for this independent aircraft ground movement is significantly and substantially reduced to a very minimal amount. The amount of fuel normally needed to ensure that the aircraft was able to move as required on the ground is now not needed. Additionally, since the engines are shut off, FOD damage to engine components is not a concern, and engines can operate efficiently with less fuel during flight. It is not necessary to apply an aircraft's brakes to reduce the aircraft's speed since braking action can be accomplished with the onboard electric driver. As a result, ground travel is significantly smoother than in the past.

The aircraft's ground movement is not controlled by the aircraft's main engines, but by an onboard electric drive assembly, which uses only the aircraft's auxiliary power unit (APU) as a power source. Consequently, not only is there a significantly decreased likelihood of engine damage, brake damage, and airframe damage, but large reductions in brake usage and, thus, brake replacement and maintenance are also achieved. Additionally, significant fuel savings accompany this significantly reduced engine use, decreased damage, and reduced maintenance.

An aircraft that will benefit by the method of the present invention is equipped with at least one drive wheel powered by a controllable onboard electric drive assembly that includes a drive means capable of moving the aircraft independently as required on the ground between landing and takeoff. The onboard drive assembly and drive means may be located on either the main landing gear wheels or on the nose landing gear wheels. Alternatively, the drive assembly and/or drive means could be located in the aircraft hold or in another suitable location within the body of the aircraft. A drive assembly with electric drive means preferred in the present method will be mounted in driving relationship with one or more of the aircraft wheels to move the wheels at a desired speed and torque. A preferred mounting location for the drive assembly is on one or both of the nose wheels. The drive assembly could also be mounted on one or more of the aircraft's main wheels. As noted above, the preferred onboard electric drive assembly drive means is powered by the aircraft's auxiliary power unit (APU).

The drive means may be an electric drive motor and/or motor assembly useful for this purpose and may be selected from any type of suitable motor known in the art. One drive means preferred for this purpose is a high phase order electric motor of the kind described in, for example, U.S. Pat. Nos. 6,657,334; 6,838,791; 7,116,019; and 7,469,858, all of which are owned in common with the present invention. A geared motor, such as that shown and described in U.S. Pat. No. 7,469,858, is designed to produce the torque required to move a commercial sized aircraft at an optimum speed for ground movement. The disclosures of the aforementioned patents are incorporated herein by reference. Any form of electric motor or other motor capable of driving an aircraft on the ground, including, but not limited to, electric induction motors, permanent magnet brushless DC motors, switched reluctance motors, hydraulic pump/motor assemblies, and pneumatic motors may also be used. Other motor designs capable of high torque operation across a desired speed range that can be integrated into an aircraft drive wheel assembly to function as described herein may also be suitable for use in extending aircraft brake life, aircraft airframe life, aircraft engine life, and improving aircraft economic life according to the method of the present invention.

To illustrate the extended economic life of an aircraft possible with the method of the present invention, consider that a new fitted out Boeing 737-800 has a list price of about US$70 million. There are substantial real savings that are realized by avoiding or postponing the purchase of a new aircraft and, instead, keeping an existing aircraft flying for an additional 5 or 10 years in accordance with the present method by equipping the existing aircraft with the powered onboard electric drive assembly described above. If the existing aircraft is kept in the fleet another 10 years, the savings from not making the investment in a new aircraft (assuming a US$70 million purchase price) at a cost of money of 5% is about US$3.5 million per year, or a total savings of US$35 million over the ten years. The present discounted value of an income stream of US$3.5 million for 10 years at a 20% discount rate is worth approximately US$15 million. If the purchase is put off for only 5 years, this, then, is a savings of over US$17 million. At a 20% discount rate, the present discounted value of this savings is over US$10 million. This compares with an industry figure of about US$4 million per year resulting from postponing the purchase of a new 737NG. Avoiding the purchase of a new aircraft and keeping an existing aircraft flying for an additional 5 or 10 years clearly produces substantial real savings.

Retrofitting an existing aircraft with an electric drive assembly as described herein can further increase the economic life of older aircraft as indicated, which allows for the capture of the savings discussed above. It is estimated that the efficiencies possible with the method of the present invention should add at least 5 years, and likely more than a decade, to the economic life of a commercial aircraft. Therefore, it will now be economically more attractive and cost effective to continue to fly an older aircraft that has been retrofitted and equipped with an onboard electric drive assembly than to purchase a new aircraft. This allows airlines to defer new aircraft purchases.

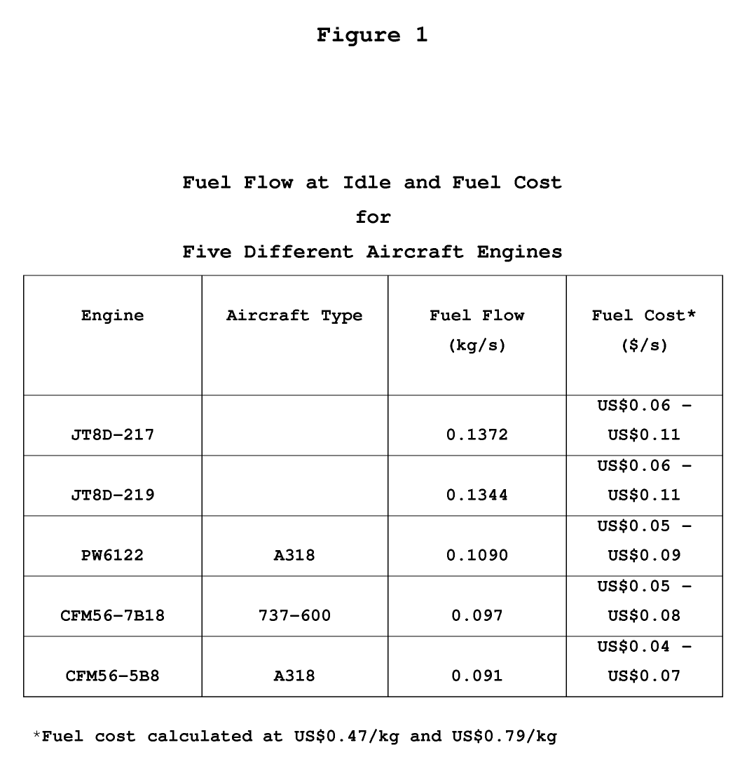

Another example of the cost effectiveness of the present method is illustrated in FIG. 1, which compares the fuel usage at idle and fuel cost for several different aircraft engines. The amount of fuel flow during aircraft engine operation ranges from about 0.091 kg/s to about 0.14 kg/s. At current fuel prices of about US$0.47 to about US$0.79 per kilogram of jet fuel, it costs an airline from about US$0.04/s to about US$0.07/s at the low fuel flow range to about US$0.07/s to US$0.11/s at the higher fuel flow range for each second the aircraft idles on the ground with the engines operating. Additional fuel savings are realized with the present method because engine operation is not required during idle or during the time when the aircraft is actually traveling on the ground. The actual fuel cost savings will, of course, depend on the price of fuel when the costs are calculated. In any event, none of this fuel is needed to operate engines on the ground, and this is one cost of operating an aircraft that is significantly and substantially reduced with the present method. It has been estimated that the method of the present invention could produce an annual fuel reduction savings of about 10% for a single aircraft.

The substantial real savings that can be achieved by extending the useful life of an aircraft's brakes, airframe, landing gear, and engines by not operating an aircraft's engines to move an aircraft or attaching tow vehicles during ground travel and by the significant fuel reduction and savings possible with the present method can keep an existing aircraft flying for 5 or 10 or possibly more additional years. The capital investment required to replace an aging aircraft can then be avoided for this period of time.

The FOD reduction possible with the method of the present invention results in more efficient flight operation of engines and significantly less fuel used in moving an aircraft on the ground by the aircraft's APU rather than the engines. Additionally, the present method substantially eliminates damage and wear to the aircraft's brakes, airframe, and landing gear caused by the jolting and uneven applications of power and braking that occur when the aircraft is moved on the ground by engine operation and/or by tow vehicles.

The method for extending aircraft engine life and improving aircraft economic life described herein has been described with respect to preferred embodiments. Other, equivalent, processes and structures are also contemplated to be within the scope of the present invention.

### INDUSTRIAL APPLICABILITY

The method of the present invention has wide applicability in achieving increased aircraft operating efficiency and extending aircraft useful economic life. The significant and substantial reduction in brake wear and damage, landing gear damage and wear, and airframe shocks all result in an extended aircraft economic life, with the result that the aircraft operates more economically than at present. The efficient aircraft operation possible with the present method results in large part from eliminating FOD damage caused by operation of an aircraft's engines on the ground when the aircraft is idle or moving. Moreover, economic efficiencies achieved as a result of fuel savings extend an aircraft's economic life.

1. A method comprising increasing the useful operational and economic life of an aircraft, further comprising moving an aircraft independently during taxi between landing and takeoff, thereby reducing physical damage to the aircraft's airframe caused by towing with a tow vehicle, reducing damage to the aircraft's brakes caused by the uneven application of brakes during aircraft taxi with engines operating on the ground, reducing damage to the aircraft's nose landing gear caused by shocks to the aircraft when brakes are not applied smoothly and tow vehicles are attached, and reducing damage to the aircraft's engine caused by foreign object debris.

2. The method of claim 1, wherein said aircraft is operated during taxi without reliance on the aircraft's main engines or external tow vehicles, thereby producing fuel savings during operation of the aircraft on the ground and in flight.

3. The method of claim 2, wherein said aircraft is operated on the ground by equipping one or more aircraft wheels with controllable onboard drive means capable of producing torque required to move a commercial sized aircraft at an optimum speed for ground movement.

4. The method of claim 3, wherein said drive means comprises any motor capable of producing the torque required to move a commercial sized aircraft at optimum ground speeds without jolts or shocks to the airframe and without brake wear.

5. The method of claim 3, wherein said drive means comprises a motor selected from the group consisting of electric induction motors, permanent magnet motors, brushless DC motors, switched reluctance motors, hydraulic pump/motor assemblies, and pneumatic motors.

6. The method of claim 3, wherein one or more of said aircraft nose wheels is equipped with said drive means.

7. The method of claim 3, wherein one or more of said aircraft main wheels is equipped with said drive means.

8. The method of claim 3, wherein said drive means is controllable to substantially eliminate damage from foreign object debris, thereby improving aircraft engine performance and efficiency in the air.

9. The method of claim 3, wherein said drive means is controllable to substantially eliminate damage to an aircraft's airframe and brakes from attachment of the aircraft to a tow vehicle.

10. The method of claim 3, wherein said drive means is controllable to operate said aircraft to maintain a smooth taxi speed without application of the aircraft brakes, thereby substantially eliminating damage to the aircraft brakes during taxi.

11. The method of claim 3, wherein said drive means is controllable to move said aircraft independently of operation of aircraft main engines, thereby substantially eliminating operation of said aircraft main engines and substantially eliminating damage to aircraft components and structures caused by operation of said aircraft engines during ground travel.

12. The method of claim 3, wherein said aircraft comprises an aging aircraft and one or more aircraft nose wheels or main wheels are retrofitted with drive means, whereby the economic value of said aircraft is increased and the operational life of said aircraft is extended beyond a predicted useful life for said aircraft.

13. The method of claim 12, wherein the economic viability of retaining said aging aircraft in an airline's fleet is maintained.

14. The method of claim 12, wherein said method comprises a cost-effective way to extend useful and economic life of aircraft.

15. A method comprising simultaneously extending an aircraft's useful life and economic life by providing an aircraft with at least one electric powered drive wheel assembly comprising drive means controllable to drive one or more aircraft nose or main wheels to move the aircraft during taxi independently of the aircraft main engines or external tow vehicles.

16. The method of claim 15, wherein the drive means comprises any electric motor capable of producing the torque required to move a commercial sized aircraft at optimum speeds on the ground without jolts or shocks to the airframe and without brake wear.

17. The method of claim 16, wherein the drive means comprises an electric motor selected from the group comprising induction motors, high phase order motors, permanent magnet brushless DC motors, and switched reluctance motors.

18. A method comprising achieving fuel savings in aircraft operation on the ground and in flight by providing an aircraft with at least one onboard electric powered drive wheel assembly mounted on a nose wheel or a main wheel to drive the aircraft during taxi on the ground independently of the aircraft engines or an external tow vehicle, thereby substantially eliminating fuel required to move the aircraft on the ground and damage to aircraft turbines from foreign object debris, causing the aircraft engines to be fuel efficient in flight.
